(19) United States
(12) Patent Application Publication
(10) Pub. No.: US 2005/0208432 A1
(43) Pub. Date: Sep. 22, 2005

(54) Methods of forming a microlens array over a substrate

(75) Inventors: John F. Conley JR., Camas, WA (US); Yoshi Ono, Camas, WA (US); Wei Gao, Vancouver, WA (US)

Correspondence Address: DAVID C RIPMA, PATENT COUNSEL;SHARP LABORATORIES OF AMERICA, 5750 NW PACIFIC RIM BLVD, CAMAS, WA, 98607, US

(73) Assignee: Sharp Laboratories of America, Inc.

(21) Appl. No.: 10/805,115

(22) Filed: Mar. 19, 2004

(51) Int. Cl. G02B 3/00

(52) U.S. Cl. 430/321; 430/323

(57) ABSTRACT

A method of forming a microlens structure is provided along with a CCD array structure employing a microlens array. An embodiment of the method comprises providing a substrate having a surface with photo-elements on the surface; depositing a transparent material overlying the surface of the substrate; depositing and patterning a photoresist layer overlying the transparent material to form openings to expose the transparent material; introducing a first isotropic etchant into the openings and etching the transparent material where exposed to form initial lens shapes having a radius; stripping the photoresist; exposing the transparent material to a second isotropic etchant to increase the radius of the lens shapes; and depositing a lens material overlying the transparent material, whereby the lens shapes are at least partially filled with lens material. An embodiment of the CCD array comprises an array of CCD pixels on a substrate; and a lens array in contact with the array of CCD pixels; wherein the lens array comprises a transparent material having concave indentations, and a lens material at least partially filling the concave indentations forming a plano-convex lens in contact with the transparent material.

### BACKGROUND OF THE INVENTION

The present method relates to methods of forming microlens structures on a substrate.

Increasing the resolution of image sensors requires decreasing pixel size. Decreasing pixel size reduces the photoactive area of each pixel, which can reduce the amount of light sensed by each pixel.

### BRIEF DESCRIPTION OF THE DRAWINGS

FIG. 1 is a cross sectional view of a microlens structure overlying a substrate.

FIG. 2 is a cross-sectional view of an intermediate microlens structure overlying a substrate.

FIG. 3 is a cross-sectional view of an intermediate microlens structure overlying a substrate.

FIG. 4 is a cross-sectional view of an intermediate microlens structure overlying a substrate.

FIG. 5 is a cross-sectional view of an intermediate microlens structure overlying a substrate.

FIG. 6 is a cross-sectional view of an intermediate microlens structure overlying a substrate.

FIG. 7 is a cross-sectional view of an intermediate microlens structure overlying a substrate.

FIG. 8 is a cross-sectional view of an intermediate microlens structure overlying a substrate.

FIG. 9 is a cross-sectional view of an intermediate microlens structure overlying a substrate.

FIG. 10 is a cross-sectional view of an intermediate microlens structure overlying a substrate.

### DETAILED DESCRIPTION OF THE INVENTION

Accordingly, a method is provided to form a microlens to increase the light impinging on each pixel of an active photodetector device. If the microlens is fabricated properly to provide the proper shape and position, the microlens will direct light impinging on the lens onto the photodetector pixel. If the microlens has an area larger than the pixel area, it can collect light that would normally impinge on the areas outside each individual pixel and direct the light onto the photodetector pixel. Increasing the amount of light impinging on the photodetector pixel will correspondingly increase the electrical signal produced by the pixel.

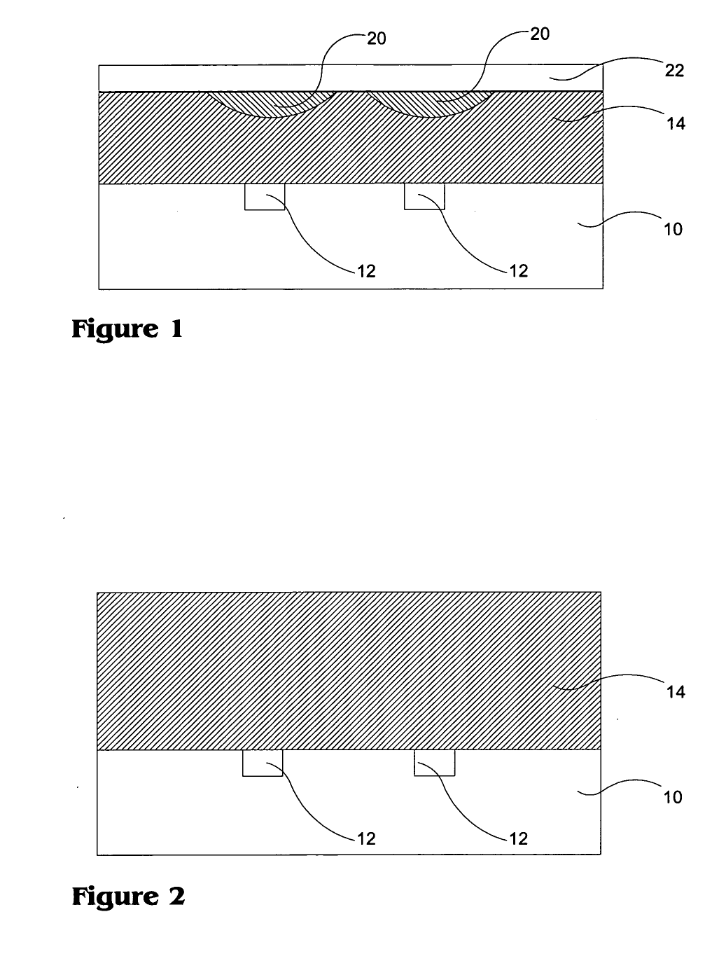

FIG. 1 shows an embodiment of a microlens structure formed according to an embodiment of the present method. A substrate 10 has at least one photo-element 12 formed thereon. The photo-elements 12 may be photosensitive elements, for example CCD camera pixels; or photosensors, or photoemissive elements. A transparent layer 14 has been deposited overlying the substrate 10. A microlens 20 is formed above a photo-element 12. An anti-reflection layer 22 is formed overlying the microlens 20. The microlens 20 is an approximately plano-convex lens with the convex surface directed towards the photo-element 12. The thickness of the transparent layer 14 will be determined, in part, based on the desired lens curvature and focal length considerations. While having light impinge on the planar surface first, instead of the convex surface, increases known aberrations, this is less critical in the present application, which is concerned with increasing the amount of light impinging on each photo-element 12, rather than trying to clearly focus an image.

In one embodiment of the present process, microlenses 20 are formed overlying the photo-elements 12, eliminating the need to form the lenses and then transfer them to the substrate. Accordingly, a substrate having the desired photo-elements 12 formed on the substrate is prepared. FIG. 2 shows a substrate 10 having pixels 12 for sensing light. A transparent layer 14 has been deposited overlying the pixels.

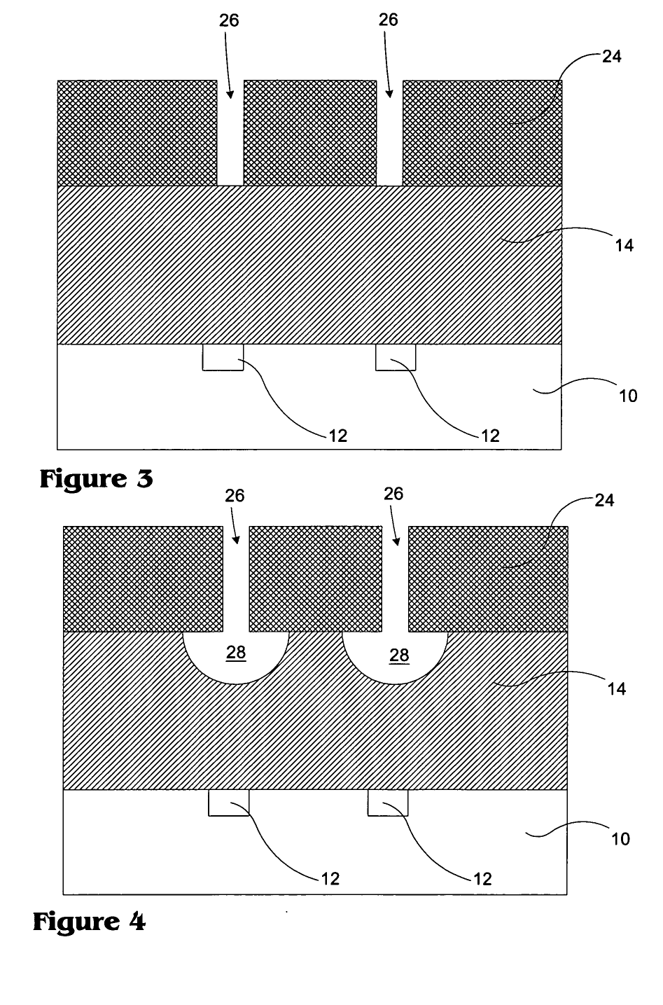

FIG. 3 shows a layer of photoresist 24 deposited overlying the transparent layer 14. As shown, openings 26 have been patterned into the photoresist. The openings 26 will be used to introduce an etchant, and should be made as small as possible while still allowing introduction of the etchant.

Next an isotropic wet etch is performed by introducing an etchant through the openings 26 to etch the transparent layer 14. If the openings 26 are sufficiently small, they will act like a point source of etchant, producing a generally hemispherical etch pattern in the transparent layer 14. If the transparent layer is silicon dioxide, buffered HF may be used as the etchant. This etch step produces the initial lens shapes 28 as shown in FIG. 4. The etch time may need to be limited to avoid lift-off of the photoresist 24.

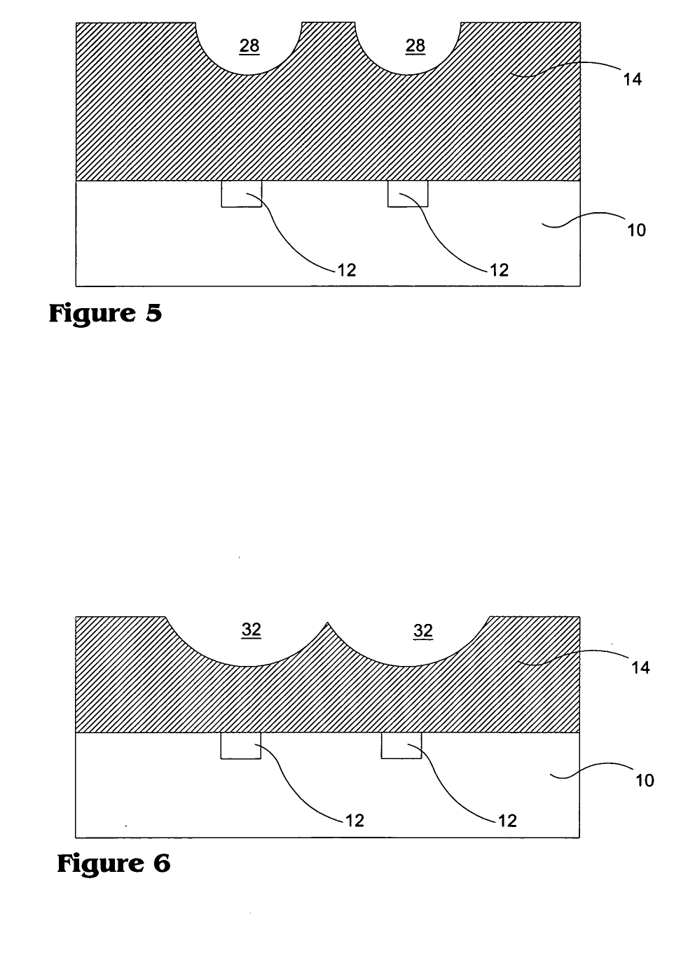

Once the initial lens shapes 28 have been formed, the photoresist is then stripped, leaving the initial lens shapes 28 exposed as shown in FIG. 5.

A second isotropic wet etch, possibly using the same etchant as that used for the first isotropic wet etch, increases the radius of the initial lens shapes to produce a final lens curvature, as shown in FIG. 6. The overall thickness of the transparent layer 14 will also be reduced during this second isotropic wet etch process, so the original thickness of the transparent layer should be thick enough to account for the reduction caused by the second isotropic wet etch. As the radius of curvature of adjacent lens shapes 32 increases, they may overlap. This is not an undesirable effect as it increases the density of the lens array, while desirably collecting as much light as possible. If the entire surface is covered with an array of lenses with no space in between, hopefully all light impinging on the surface of the lens array will be focused onto the underlying array of photo-elements 12.

In one embodiment of the present method, after the final lens curvature has been achieved, the distance between the lens shape 32 and the underlying pixel 12 can be fine tuned using an anisotropic etch. An anisotropic etch, for example a dry etch process, will reduce the thickness of transparent layer 14 while essentially maintaining the lens shape 32. This allows the lens shape to essentially be moved closer to the pixel 12. If the transparent layer 14 is silicon dioxide, a fluorine-based anisotropic etchant may be used, for example a fluorocarbon such as C₃F₈ with argon. The ratio of C and F can be modified to change the etch profile.

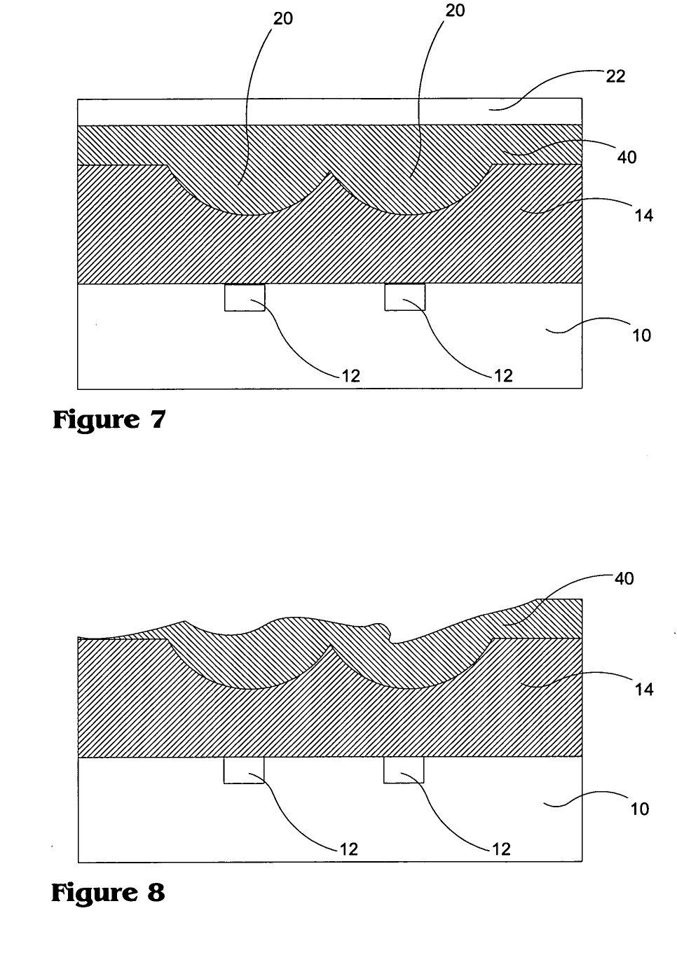

As shown in FIG. 7, once the lens shape 32 is formed, and repositioned if desired, a lens material 40 is deposited to fill the lens shapes 32. The lens material may be deposited by a sputtering process, a CVD process, a spin-on process, or other suitable process. If a spin-on process is used, further smoothing of the upper planar surface may not be necessary. In this case, lenses 20 have been formed. In one embodiment of the present process an anti-reflection (AR) layer 22 is formed over the lenses 20. The anti-reflection layer 22 may be a single layer of material with a refractive index value between that of the lens material 40 and air. In another embodiment, a multilayer AR coating is used. The AR layer 22 may be deposited by a sputtering process, a CVD process, a spin-on process, or other suitable process. If desired, a CMP process may be used to planarize the upper surface of the AR layer 22.

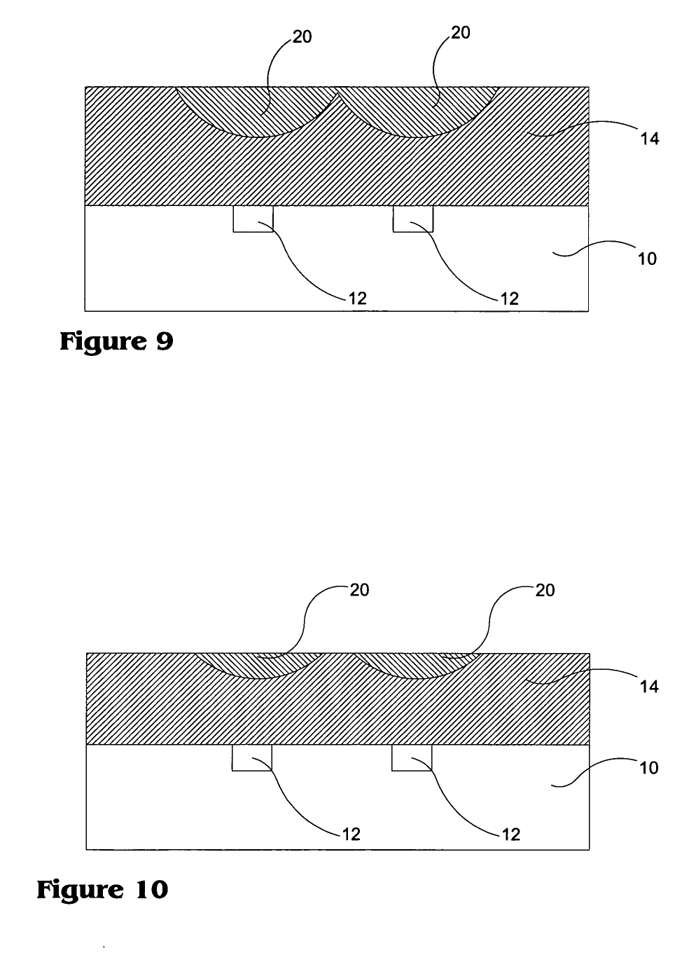

If the lens material 40 is rough, as shown in FIG. 8, a planarizing step is performed. In an embodiment of the present method, a CMP process is used to planarize the lens material 40. Alternatively, a reflow process is used to achieve planarization of the lens material 40. The amount of planarizing is not critical as long as enough lens remains to achieve improved light collection. FIG. 9 shows lenses 20 still overlapping, while FIG. 10 shows that substantially more lens material 40 has been removed, leaving separated lenses 20. After planarizing is achieved, the AR layer 22 may be applied, producing the final structure shown in FIG. 1.

Referring again to FIG. 1, the substrate may be composed of any suitable material for forming or supporting a photo-element 12. For example in some embodiments, the substrate 10 is a silicon substrate, an SOI substrate, quartz substrate, or glass substrate.

In an embodiment of the present microlens structure, wherein it is desirable to concentrate light onto the photo-element 12, the transparent layer 14 will have a lower refractive index than microlenses 20. For example, if the transparent layer 14 has a refractive index of approximately 1.5, the microlenses 20 should have a refractive index equal to or greater than approximately 2. If the transparent layer 14 is silicon dioxide or glass, the microlenses 20 are composed of HfO₂, TiO₂, ZrO₂, ZnO₂, or other lens material with a refractive index of approximately 2 or higher.

In an embodiment of the present microlens structure comprising a single material AR layer 22, the AR layer is preferably composed of a material with a refractive index between that of air and the lens material. For example, silicon dioxide may be used over microlenses having a refractive index of approximately 2.

The thickness of the transparent layer 14 will be determined, in part, based on the desired lens curvature and focal length considerations, as well as the amount of etching caused by the second isotropic wet etch. In one embodiment of the present microlens structure, the desired focal length of the microlenses 20 is between approximately 2 μm and 8 μm. The thickness of the transparent layer 14 as deposited should be thick enough to achieve the desired focal length distance following all etching and planarization steps.

Note that since the microlens structures are formed directly overlying the photo-elements 12, there is no need to provide a separating layer, or to transfer the lens structure from a separate mold and reposition it.

Although embodiments have been discussed above, the coverage is not limited to any specific embodiment. Rather, the claims shall determine the scope of the invention.

1. A method of forming a microlens structure comprising:
a) providing a substrate having a surface with photo-elements on the surface;
b) depositing a transparent material overlying the surface of the substrate;
c) depositing and patterning a photoresist layer overlying the transparent material to form openings to expose the transparent material;
d) introducing a first isotropic etchant into the openings and etching the transparent material where exposed to form initial lens shapes having a radius;
e) stripping the photoresist;
f) exposing the transparent material to a second isotropic etchant to increase the radius of the lens shapes; and
g) depositing a lens material overlying the transparent material, whereby the lens shapes are at least partially filled with lens material.

2. The method of claim 1, wherein the transparent material is silicon dioxide, or glass.

3. The method of claim 2, wherein the first isotropic etchant is buffered HF.

4. The method of claim 1, wherein the lens material has a higher refractive index than the transparent material.

5. The method of claim 2, wherein the lens material comprises HfO₂, TiO₂, ZrO₂, or ZnO₂.

6. The method of claim 1, further comprising forming an AR coating overlying the lens material.

7. The method of claim 5, further comprising forming a single layer AR coating overlying the lens material.

8. The method of claim 7, wherein the single layer AR coating comprises silicon dioxide, or glass.

9. The method of claim 1, further comprising planarizing the lens material.

10. The method of claim 9, wherein planarizing the lens material comprises chemical mechanical polishing.

11. The method of claim 9, wherein planarizing comprises reflowing the lens material.

12. The method of claim 1, further comprising adjusting the overall thickness of the transparent material prior to depositing the lens material by using an anisotropic etchant to etch the transparent material.

13. The method of claim 12, further comprising planarizing the lens material.

14. The method of claim 13, further comprising forming an AR coating overlying the lens material.

15. A method of forming a microlens array over a CCD array comprising:
a) providing a substrate comprising the CCD array;
b) depositing a transparent layer comprising silicon dioxide, or glass overlying the CCD array;
c) depositing and patterning a photoresist layer overlying the transparent layer to form openings to expose the transparent material;
d) introducing a first isotropic etchant into the openings and etching the transparent material where exposed to form initial lens shapes having a radius;
e) stripping the photoresist;
f) exposing the transparent material to a second isotropic etchant to increase the radius of the lens shapes;
g) depositing a lens material comprising HfO₂, TiO₂, ZrO₂, or ZnO₂ overlying the transparent material, whereby lenses are formed by the lens material at least partially filling the lens shapes;
h) planarizing the lens material using CMP; and
i) forming an AR coating overlying the lens material.

16. A CCD array comprising:
a) an array of CCD pixels on a substrate; and
b) a lens array in contact with the array of CCD pixels; wherein the lens array comprises a transparent material having concave indentations, and a lens material at least partially filling the concave indentations forming a plano-convex lens in contact with the transparent material.

17. The CCD array of claim 16, wherein the transparent material comprises silicon dioxide, or glass.

18. The CCD array of claim 16, wherein the lens material comprises HfO₂, TiO₂, ZrO₂, or ZnO₂.

19. The CCD array of claim 16, further comprising an AR coating overlying the plano-convex lens.
